(19) United States
(12) Patent Application Publication
(10) Pub. No.: US 2025/0303202 A1
(43) Pub. Date: Oct. 2, 2025

(54) Apparatus, System, and Method for Pressure Altitude-Compensating Breath-Controlled Oxygen Release

(71) Applicant: The Boeing Company, Arlington, VA (US)

(72) Inventors: Jon A. Feroy, Edgewood, WA (US); Frederick Paul Siebert, North Bend, WA (US); Emad Said Kiriakos, Bothell, WA (US); Douglas L. Dohrman, Snohomish, WA (US); Steven P. McDonald, Marysville, WA (US); Raydel Cortina, Hialeah, FL (US); Timothy R. Randall, Seattle, WA (US); Cory Christopher Haven, Federal Way, WA (US); Gregory Dale Perrigo, Woodinville, WA (US); Brianna Renee Allen, Bonney Lake, WA (US)

(21) Appl. No.: 19/237,623

(22) Filed: Jun. 13, 2025

Related U.S. Application Data
(63) Continuation-in-part of application No. 16/830,861, filed on Mar. 26, 2020, now Pat. No. 12,329,997.

(51) Int. Cl. A62B 7/14; A62B 9/02

(52) U.S. Cl. CPC A62B 7/14; A62B 9/022

(57) ABSTRACT

Methods, apparatuses, and systems for mechanically releasing a predetermined amount of supplemental oxygen to a user via a mechanical initiator are disclosed with the release of the amount of supplemental oxygen based on and in response to the combined factors of a user's determined oxygen consumption based on sensing a user's inhalation combined with determining the ambient pressure in the area of the user.

### RELATED APPLICATION

This application is a continuation-in-part of application Ser. No. 16/830,861, filed on Mar. 26, 2020, which is hereby incorporated by reference in its entirety.

### TECHNOLOGICAL FIELD

The present disclosure relates generally to the field of oxygen delivery. More specifically the present disclosure relates to the field of oxygen flow control apparatuses, systems and methods.

### BACKGROUND

In various environments, the oxygen content in ambient air can be altered just enough to have a perceptible effect on a human. For example, at higher altitudes on land, performance levels during physical exertion or even when a body is at rest may be impacted by a drop in oxygen concentration in ambient air of even less than 1 percent. Further, in enclosed spaces where air is conditioned and circulated, including, buses, trains, buildings, etc., minor fluctuations in oxygen content can occur.

In addition, during air travel, cabin pressurization and ambient air circulation is optimized to deliver oxygen content to passengers approaching or approximating oxygen levels on land. The control and dispensing of oxygen on an aircraft is of particular importance during a decompression event, where supplemental oxygen is dispensed generally to passengers from systems typically stowed in overhead compartments.

### SUMMARY

The present disclosure includes apparatuses, systems, and methods for delivering supplemental oxygen to a user by mechanically initiating a conserved flow of oxygen, with the conserved individualized flow of oxygen determined for an individual user based on the inhalation of the user in combination with the determined ambient pressure of the area inhabited by the user, and with the conserved individualized flow of oxygen delivered to the user on demand, and in substantially real time.

According to present aspect an apparatus is disclosed including an oxygen control unit, with the oxygen control unit including an orifice metering device, and with the orifice metering device configured to determine ambient pressure, and with the orifice metering device further configured to regulate oxygen flow in response to a determined ambient pressure. The oxygen control unit further includes a breath sensor, with the breath sensor in communication with the orifice metering device, and with the breath sensor configured to mechanically regulate oxygen flow in response to the inhalation of a user. The oxygen control unit further includes a time delay circuit in communication with orifice metering device and with the time delay circuit further in communication with the breath sensor, and with the time delay circuit configured to determine the duration of a dosed oxygen flow. The apparatus further includes a mechanical oxygen flow initiator in communication with the oxygen source

In another aspect, the orifice metering device comprises an aneroid controlled metering device.

A further aspect is directed to a system including an oxygen source, a regulator, with the regulator in communication with the oxygen source, and with the regulator configured to regulate pressure of oxygen from the oxygen source. The system further includes an oxygen control unit in communication with the regulator, and with the said oxygen control unit including an orifice metering device, with the orifice metering device configured to determine ambient pressure and further configured to regulate oxygen flow in response to the determined ambient pressure. The system further includes a breath sensor, with the breath sensor in communication with the orifice metering device, and with the breath sensor further configured to initiate oxygen flow in response to inhalation of a user. The system further includes an oxygen dosing chamber in communication with the breath sensor, with the oxygen dosing chamber further in communication with the oxygen source, and the system further includes an oxygen delivery device in communication with the orifice metering device, with the oxygen delivery device further in communication with the breath sensor, wherein the oxygen source is in communication with a mechanical oxygen supply initiator.

In another aspect, an oxygen supply is delivered to an individual user.

In a further aspect, the system further includes an oxygen discharge indicator, with the oxygen discharge indicator in communication with the delivery device.

In another aspect, the system further includes a time delay circuit in communication with orifice metering device and further in communication with a breath sensor, with the time delay circuit configured to determine the duration of a dosed oxygen flow.

In another aspect, the system is configured for use by an individual user.

In a further aspect, the system is configured for use by a plurality of users.

In another aspect, the mechanical oxygen supply initiator is configured to be activated mechanically.

In a further aspect, the orifice metering device is configured to determine ambient pressure in an aircraft cabin.

In another aspect, an object includes the aforementioned system, with the object being at least one of an aircraft, a spacecraft, a rotorcraft, and a satellite.

In another aspect, the portable object includes the aforementioned system.

According to further aspects, a method is disclosed including determining an oxygen demand of a user, said oxygen demand of a user based on a user inhalation activation, said user inhalation activation determined by a breath sensor, determining the oxygen demand of the user based on determined ambient pressure of a region inhabited by the user, and mechanically releasing on demand a predetermined dose of oxygen in response to the determined oxygen demand based on the inhalation activation of the user as determined by the breath sensor and as determined by the ambient pressure of the region inhabited by the user.

In another aspect, the method further includes directing the predetermined dose of oxygen to the user.

In another aspect, in the step of mechanically releasing on demand a predetermined dose of oxygen in response to the determined oxygen demand, the method does not employ electrical power.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is a block diagram illustrating an apparatus, system, and method according to a present aspect;

FIG. 2 is a schematic drawing illustrating an apparatus, system, and method according to a present aspect;

FIG. 3 is a flowchart illustrating a method according to a present aspect;

FIG. 4 is a flowchart illustrating a method according to a present aspect;

FIG. 5 is an illustration of an object in the form of a vehicle, and further in the form of an aircraft including an apparatus and/or system according to a present aspect; and

FIG. 6 is an illustration of an object in the form of a portable object for personal use, including an apparatus and/or system according to a present aspect.

FIG. 7. is a schematic diagram illustrating a system of delivering tailored oxygen to an individual.

FIG. 8. is a schematic diagram illustrating a system of delivering tailored oxygen to an individual.

FIG. 9. is a schematic diagram illustrating a system of delivering tailored oxygen to an individual.

FIG. 10 is a schematic drawing illustrating a system of delivering tailored oxygen to an individual.

FIG. 11 is a schematic diagram of an aneroid flow switching valve.

FIG. 12 is a flowchart diagram of a method of delivering tailored oxygen to an individual.

FIG. 13 is a flowchart diagram of a method of delivering tailored oxygen to an individual.

### DETAILED DESCRIPTION

Typical oxygen dispensing systems have a largely unrestricted flow of oxygen flow that is typically controlled and/or initiated by a primary or secondary aircraft electrical system. Such systems require the accompanying electrical hardware including, for example, electrical wiring, electrical circuitry, etc. Such systems dependent on electrical connection can further require the presence of auxiliary or “back-up” electrical systems (e.g., auxiliary battery-powered systems) if a primary loss of electrical power occurs. The electrical components can add significant weight to a large structure such as, for example, an aircraft. Further, the weight of oxygen cylinders and the number of oxygen cylinders required to dispense the typical uninterrupted flow of oxygen to aircraft passengers during a decompression event further adds total weight to the aircraft, that can increase cost, limit payload, limit aircraft range, increase fuel consumption, and otherwise increase operational cost, etc.

Present aspects disclose apparatuses, systems, and methods for increasing the efficiency of the delivery of oxygen on-demand to a user through the conserved and customized or release of oxygen to an individual user through an on-demand, mechanically controlled, oxygen delivery system that senses point-to-point demand by a user and that accounts for the altitude pressure of a user to, in combination, regulate oxygen flow and delivery to a user.

Further present aspects disclose an on-demand oxygen delivery system to a user that is mechanically driven (e.g., pneumatically driven without electrical assistance, etc.), and that conserves oxygen, with oxygen dosages from the system delivered to a user based on “sensed” or determined demand, with the system delivering oxygen dosages to a user based, at least in part, on predetermined oxygen requirements of a user based on altitude pressure (also equivalently referred to herein as “ambient pressure”), with the systems adjusting regulated oxygen dosages that are delivered mechanically on-demand based on perceived (e.g., sensed) altitude pressure at the location of the user.

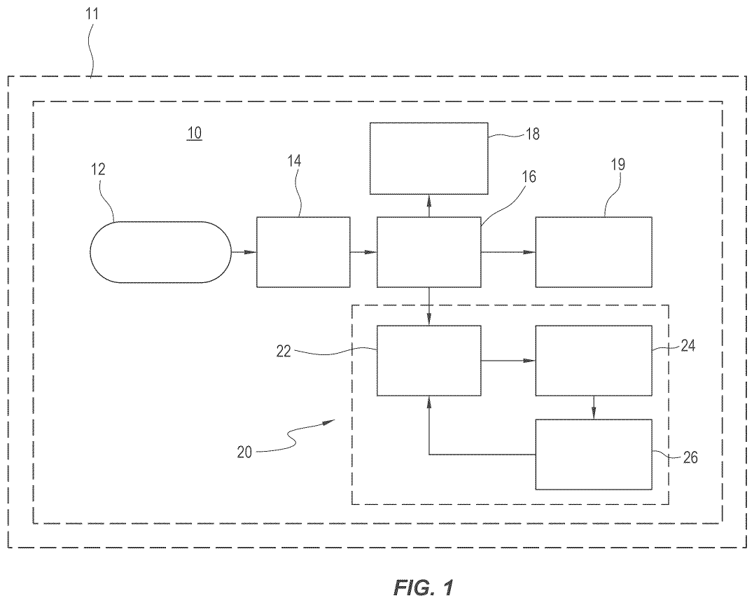

FIG. 1 is a non-limiting illustration showing an apparatus 10 for delivering oxygen to a user according to present aspects. The apparatus 10 includes an oxygen source 12, shown in FIG. 1, in non-limiting fashion, as an oxygen cylinder, although present aspects also contemplate an oxygen source that is provided to the apparatus from a source other than an oxygen cylinder. The apparatus 10 can be included within, or as a part of, a larger apparatus such as, for example, a passenger service unit 11 (referred to equivalently herein as a “PSU”). The oxygen source, as shown in FIG. 1, is in communication with a rupture disk 14 that, when ruptured, facilitates an oxygen flow to a regulator 16. The rupture disk 14, shown in FIG. 1 as a separate component, can also be incorporated into the oxygen source, or incorporated into a component other than the oxygen source that is in communication with the oxygen source for the purpose of containing oxygen in a source, and then facilitating the release of an oxygen flow from the oxygen source once the rupture disk is pierced. In FIG. 1, the regulator 16 is shown in communication with: 1) an oxygen discharge indicator 18; 2) an oxygen flow control unit 20 (referred to equivalently herein as a “flow control unit”); and a mechanical initiator 19. According to alternate aspects, though not explicitly shown in FIG. 1, the rupture disk 14 and the oxygen discharge indicator 18 can be incorporated into other components in the apparatus 10 and not be discrete elements.

As shown in FIG. 1, the regulator 16 can be of a type used to regulate oxygen flow from an oxygen source, through an oxygen delivery system and to a delivery device accessible by an end user. As shown in FIG. 1, the oxygen flow control unit 20 includes a time delay circuit 22 that can be in communication with the regulator 16, with the time delay circuit at least partially controlling the flow of oxygen that can be a dosed flow of oxygen, An orifice metering device 24 that can be, for example, an aneroid orifice meter, etc., is shown in communication with the time delay circuit 22 and further in communication with a breath sensor 26.

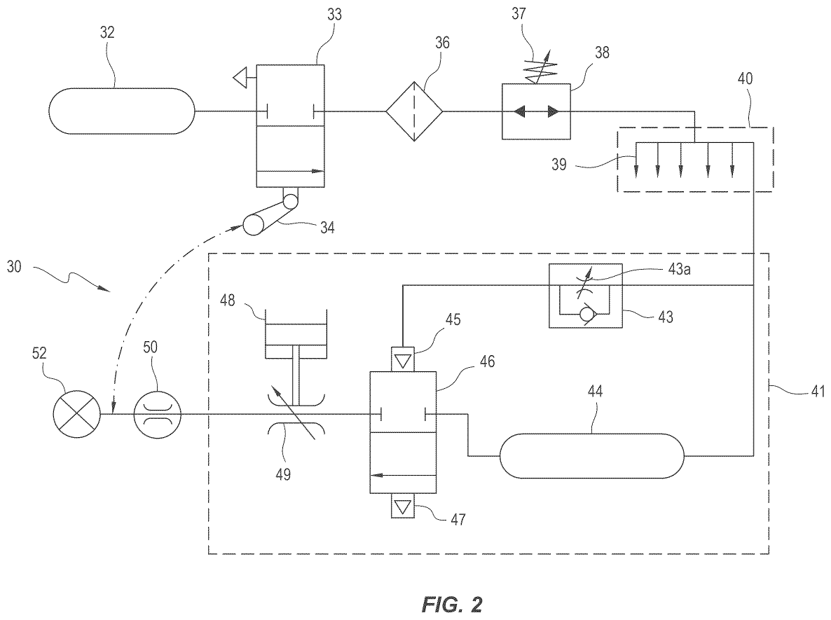

As further shown in FIG. 1, a breath sensor 26 is in communication with the time delay circuit 22, with the breath sensor 26 capable of sensing a breath demand of a user via sensing inhalation demand of a user, and the breath sensor 26 can generate a signal, and deliver the signal to the time delay circuit 22. Breath sensor 26 detects, or otherwise “senses”, a user's breath demand as a localized change in pressure triggered, for example, by a user's act of inhalation (referred to equivalently herein as a “user's inhalation” or “inhalation force”). The oxygen discharge indicator can be in communication with, or, e.g., integrated into, a delivery device 52, as shown in FIG. 2, (e.g., a mask of the type to be worn, for example, by a user requiring supplemental oxygen delivery, etc.)

According to present aspects, PSU 11, shown in FIG. 1, is understood to be an aircraft component situated, for example, in the overhead panel above passenger seats, for example, in the cabin of a passenger aircraft. Among other things, a PSU can contain, for example, reading lights, loudspeakers, illuminated signs, buttons to call for assistance, air conditioning vents, automatically deployed oxygen masks, etc.

During a cabin decompression event, presently disclosed systems and apparatuses regulate and deliver oxygen flow on demand and in an amount commensurate with an individual user's need based on, in combination, a user's breath demand and the pressure altitude (e.g. ambient pressure) of the environment inhabited by the user. According to present aspects, ambient pressure can be determined by orifice metering device (e.g., an aneroid bellows metering device). The orifice metering device senses the ambient pressure and determines the appropriate amount of oxygen flow to be delivered to a user (via controlling at least in part, for example, volume, flow rate, etc.) based on the oxygen delivery/dispensing requirements of a user at a particular pressure altitude.

According to present aspects, the incorporation and operation of the orifice metering device in the presently disclosed apparatuses and systems helps to facilitate the conservation of oxygen dispensed during, for example, a cabin decompression event. According to further present aspects, oxygen conservation and oxygen delivery efficiency is significantly enhanced by also regulating the present systems, apparatuses, and methods by taking into consideration an individual user breath demand by sensing user inhalation via an incorporated breath sensor that that senses and determines, for example, a user's breath demand in terms of, for example, breath rate, breath volume, breath force (e.g., that can determined as a function of negative pressure created by an inhalation from an oxygen delivery device such as, for example, a mask, etc.), etc. A signal is then generated by the breath sensor and delivered to the oxygen control unit that receives the signal from the breath sensor.

FIG. 2 is a non-limiting schematic illustration showing further present aspects, including further detail for a system having an oxygen delivery circuit that is used to mechanically drive presently disclosed apparatuses and systems. As shown in FIG. 2, system 30 includes an oxygen source 32, shown in FIG. 2, in non-limiting fashion, as an oxygen cylinder, although present aspects also contemplate an oxygen source provided from a source other than an oxygen cylinder. The oxygen source 32, as shown in FIG. 2, is in direct communication with a mechanical initiator 34 (e.g., an initiator that is mechanically driven, as opposed to an initiator that is electrically driven), with the mechanical initiator 34 including a valve 33 that can be a one-way valve, and an exhaust vent.

In the case of an aircraft incorporating presently disclosed systems and apparatuses, in operation, for example, during a decompression event a user (e.g., a passenger) manually activates the mechanical initiator 34, as shown in FIG. 2 as a “broken line” between the user proximate to the delivery device 52 in a deployed state and the valve 33 in communication with the mechanical initiator 34. Through the manual activation of the mechanical initiator results in the piercing of a seal (e.g. a rupture disk, etc.) releasing a flow of oxygen from the oxygen source 32 into the system 30. The released oxygen flows from the mechanical initiator and passes through filter 36 that can be any suitable oxygen filtration device for the purpose of increasing the purity of oxygen released from the oxygen source. After passing through the filter 36, the oxygen flow is delivered to a regulator 38, with the regulator comprising a flow control 37. Flow control 37 can reduce or otherwise adjust the pressure of the oxygen from an oxygen release pressure (e.g., the pressure of contained oxygen in the oxygen source) of about 3000 psi to a system pressure that can be about, for example 25 psi.

FIG. 2 further shows the oxygen supply proceeding to manifold 40 that can separate and deliver a regulated amount of oxygen flow to multiple outlets 39, with the outlets 39 feeding the oxygen control units 41. Oxygen control units 41, as shown in FIG. 2, further include an oxygen dosing chamber 44 that can be maintained at a predetermined pressure that can be at least partially filled and at least partially emptied in response to user demand as sensed by breath sensor 46. A time delay circuit 43 (with time delay circuit orifice 43a) is shown in communication with the oxygen flow and the breath sensor 46, such that, when oxygen demand (in the form of user inhalation) is sensed by the breath sensor 46, a signal is sent to the time delay circuit 43 to coincide with a dosed release from the oxygen dosing chamber 44. The breath sensor 46 further includes a breathing diaphragm 47 that opens on demand to deliver oxygen flow to a user on demand in response to user inhalation, and a conservation diaphragm 45 that closes at the end of a user inhalation (e.g., the end of an inhalation includes the duration between a user's consecutive breaths) for the purpose of conserving (e.g. terminating) oxygen flow to a user from the oxygen control unit.

Orifice metering device 48 then adjusts the dosed oxygen flow leaving the dosing chamber 44 to compensate for the amount of oxygen that is to be delivered to the user at a perceived pressure altitude (ambient pressure). The combination of the orifice metering device 48 (to account for ambient pressure and adjust the oxygen flow accordingly) and the breath sensor 46 with activated dose control (to deliver an oxygen flow, as determined by present systems, and based on a user's inhalation) results in a, safe delivery of pressure adjusted oxygen to a user, on demand, and in according to the individualized “sensed breath” demand of an individual user.

The delivery device 52 of the type shown in FIG. 2, and that can be, for example, a mask, receives the predetermined and conserved dose of oxygen flow from the oxygen source (e.g., an on-demand, dosed, oxygen flow resulting from a detected, consumed breath of a user that is adjusted for ambient pressure) through the systems, apparatuses, and methods according to present aspects, and as described herein. Oxygen discharge indicator 50 can be any device to indicate a flow of oxygen is being delivered, and although shown in FIG. 2 as a discrete device, oxygen discharge indicator 50 can be incorporated into another device, such as, for example, a device visible to a user and incorporated in the PSU, the mask/delivery device, etc.

The present apparatuses and systems can be placed into communication with an aircraft databus that collects and distributes aircraft data, including aircraft status data, with the aircraft databus able to send a signal to features of the presently disclosed systems and apparatuses. For example, information received from an aircraft databus can, for example, trigger the mechanical release of the delivery device into the proximity of an aircraft passenger, for example, in the event of a decompression event.

Further aspects contemplate the incorporation of one or more of: the oxygen control device, the components in the oxygen control unit, the oxygen discharge indicator, and a mask, into a unitary oxygen flow delivery device. In further present aspects, the delivery device, as shown in FIG. 2, is a discrete unit that can be considered as separate from the aforementioned oxygen delivery system and/or apparatus.

As stated herein, presently disclosed systems and apparatuses operate independently from, for example, an aircraft electrical system. Further present aspects, relating to the contemplated incorporation of the mechanically driven oxygen flow initiator (e.g. a mechanical initiator), obviate the need for a supplemental (e.g., a “back-up” or “reserve”) electrical system that can be dedicated to an oxygen delivery system, for example, in case of a main and/or supplemental electrical system interruption.

Such presently disclosed aspects greatly simplify known oxygen delivery systems requiring electrical operation. According to further aspects, the simplification of presently disclosed systems and apparatuses afforded by incorporating mechanically driven apparatuses, contributes to a significant weight reduction of an oxygen delivery system by, for example, obviating the need for electrical wiring into, for example, an aircraft's main electrical system, etc. Overall system weight reduction is further realized due to the conservation of expended oxygen due to the on-demand delivery and release of oxygen to a user based, in part, to the sensed cyclical inhalation breathing demand of an individual user and the system regulation and adjustment of oxygen delivery to a user based, in part, on the “sensed” ambient pressure of the user's location.

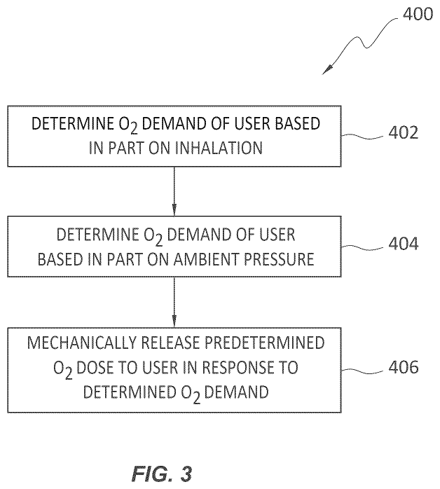

FIG. 3, 4 are flowcharts outlining non-limiting methods according to present aspects. As shown in FIG. 3, a method 400 is outlined according to present aspects, with the method including determining 402 the oxygen demand of a user based, in part, on inhalation or breath demand of a user, determining 404 the oxygen demand of a user based, in part on the ambient pressure, and mechanically releasing 406 a predetermined oxygen dose to the user in response to the determined oxygen demand.

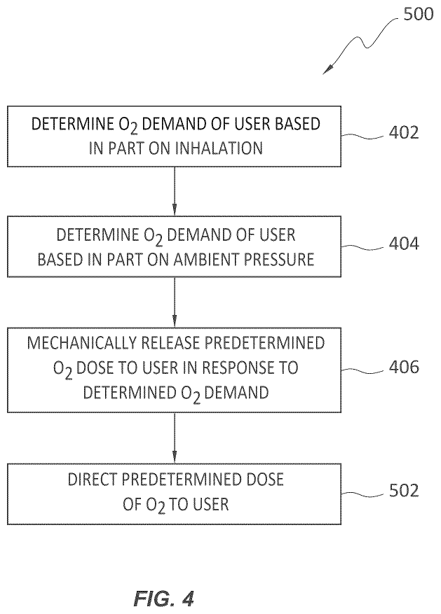

As shown in FIG. 4, a method 500 is outlined according to present aspects, with the method including determining 402 the oxygen demand of a user based, in part, on inhalation or breath demand of a user, determining 404 the oxygen demand of a user based, in part on the ambient pressure, mechanically releasing 406 a predetermined oxygen dose to the user in response to the determined oxygen demand, and directing 502 a predetermined dose of oxygen to the user. The apparatuses and systems disclosed herein can be implemented in any of the methods according to present aspects, and as illustrated in FIGS. 3 and/or 4.

The presently disclosed methods, systems, and apparatuses deliver a predetermined amount of oxygen (e.g., the predetermined amount referred to equivalently here as a “bolus” or “dose” or “dosage” of oxygen) to a user at a rate and at a total volume in substantially real time that is directly in response to user demand in combination with recognition by the system of the current altitude (referred to equivalently herein as the ambient altitude). By delivering an oxygen dosage that is provided in substantially real time in response to a user's breath or inhalation demand, considerable savings are realized as the system does not deliver a continuous and uninterrupted free flow of oxygen, and instead delivers a “right-sized” amount of dosed oxygen in response to the user's breath demand, on-demand, in combination with an oxygen release from the system that is also conditioned or regulated according to the system and apparatus determining pressure altitude (e.g., ambient pressure) of a location inhabited by a user, and that can account for and deliver an appropriate oxygen dosage during, for example, rapid or progressive ascent or descent as well as a decompression event (in the case of, for example, an aircraft). The term “substantially real time”, for present purposes, is understood to represent an amount of time that is less than about 0.5 seconds.

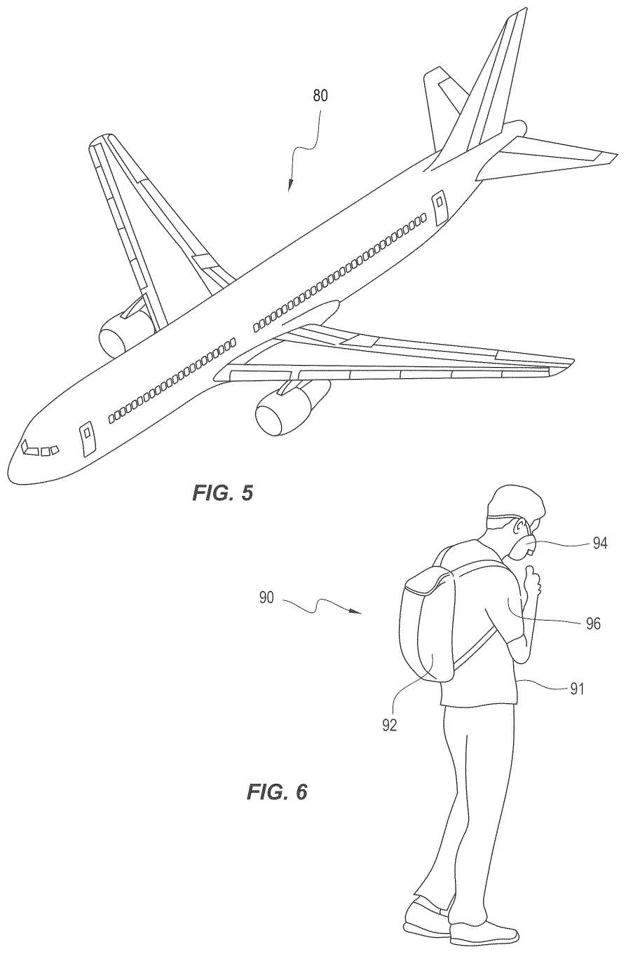

Present aspects contemplate incorporating the presently disclosed systems in objects that can be subject to high altitudes and altitudes that vary over the course of a mission or event including, for example, an aircraft flight, a climbing ascent and descent, etc. Accordingly, FIGS. 5 and 6 illustrate, in non-limiting fashion, objects that can include the systems and apparatuses according to present aspects as shown in FIGS. 1 and/or 2, and that can incorporate the methods as outlined in FIGS. 3 and/or 4.

FIG. 5 shows a vehicle in the form of an aircraft 80 that can incorporate the presented apparatuses, systems, and methods according to present aspects. In the case of an aircraft, the systems and apparatuses can be at least partially contained within or located proximate to an aircraft PSU of the kind typically located within or proximate to an overhead compartment and that can be positioned above an occupant/passenger/user. In a decompression event, an oxygen delivery device (e.g., a mask) is deployed from the PSU, and it is contemplated that the delivery device can be fashioned into the form of an oxygen mask dimensioned to at least partially cover a user's airway (e.g., mouth and/or nose). The presently disclosed apparatuses and/or systems can be incorporated in variable altitude vehicles including at least one: aircraft, spacecraft, rotorcraft, a satellite, and combinations thereof.

Present aspects can also be directed to apparatuses, systems, and methods for delivering oxygen dosages in a portable oxygen delivery device to a user, for example, a user engaged in an altitude altering activity where supplemental oxygen is desirable including, for example, high altitude climbing, high altitude hiking, high altitude skiing, skydiving, ballooning, etc. Accordingly, present aspects contemplate the delivery of a predetermined and individualized/personalized dosage of oxygen from an oxygen source, with the amount of oxygen that is released to the user as a conserved oxygen dosage or dose delivered to the user from the oxygen source in response to the respiratory demand of the user (e.g., the breath, inhalation rate and volume, etc. on-demand and in substantially real time) in combination with the oxygen delivery regulated according to the current ambient pressure inhabited by the user, with the conserved oxygen delivery achieved in substantially real time.

As shown in FIG. 6, a portable oxygen delivery device 90 in the form of an exemplary backpack includes an oxygen source 92 shown as being contained within the portable oxygen delivery device 90. In aspects, not shown, such oxygen source can be located and secured to the exterior of the portable oxygen delivery device. The oxygen source 92 is in communication with a delivery device 94 (e.g., shown as a mask) via tube 96, with the system triggered mechanically by a user, and with oxygen doses regulated by the system and apparatus to deliver an oxygen dose to the user based on 1) the user's pressure altitude (e.g., ambient pressure) as detected by the system; and 2) a user's inhalation as detected by a breath sensor. As with the systems, apparatuses, and methods described in the context of oxygen delivery and oxygen delivery conservation in an aircraft depressurization event, the personal systems and apparatuses shown in non-limiting fashion in FIG. 6 provide a user the benefits of a mechanically-triggered conserved oxygen flow, with the total oxygen flow and oxygen system consumption conserved through the individualized needs of the user in terms of delivering an oxygen flow based on user consumption as sensed by a breath sensor combined with oxygen delivery being further regulated (and conserved) in response to the detected ambient pressure of the user's surroundings. According to present aspects, the portable oxygen delivery device contains the apparatuses and systems described herein and shown in FIGS. 1 and 2, and incorporating the outlined methods presented in FIGS. 3 and 4.

The systems and methods provide a tailored oxygen flow to a user based on a combination of the sensed demand and the ambient pressure. The number of users that are provided with tailored oxygen can vary depending on the specific configuration.

In some examples, the amount of the dosed oxygen to the user is determined from the user breath demand. The amount of dosed oxygen is based on the breath sensor that senses one or more aspects of user inhalation such as but not limited to breath rate, breath volume, and breath force. In other examples, the amount of dosed oxygen is a predetermined size that is based on known human physiological needs. The dispensing of the dosed oxygen is based on breath demand as the system senses the inhalation of the user and released the dosed oxygen.

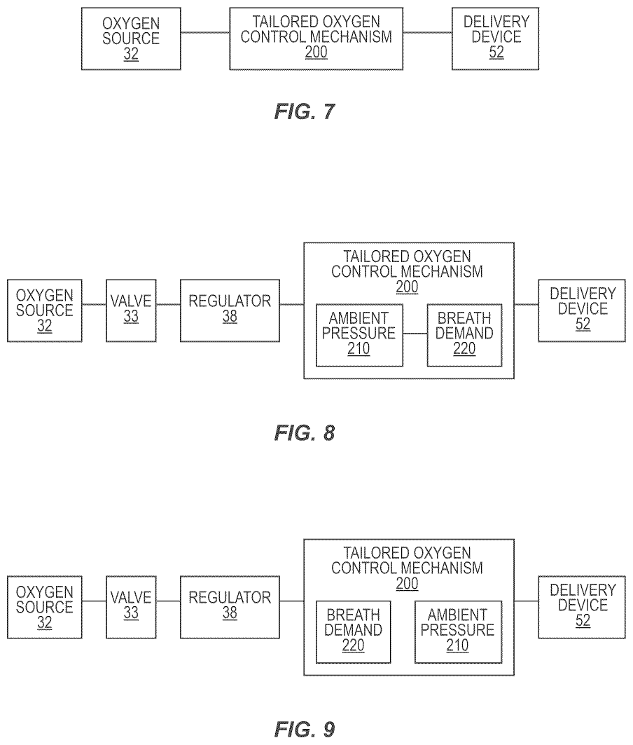

FIG. 7 illustrates an overview of an oxygen delivery system configured to supply tailored oxygen flow to one or more users. Oxygen is supplied from an oxygen source 32 to a tailored oxygen control mechanism 200. The tailored oxygen control mechanism 200 adjusts the oxygen based on a combination of a demand from the user and the ambient pressure. The oxygen is then delivered to the user through a delivery device 52. The system can also include other components to perform other functions (e.g., adjust pressure, initiate oxygen flow, filter oxygen). In some examples, the system includes a manifold to deliver oxygen to multiple different users that each have a different oxygen demand.

The arrangement of the tailored oxygen control mechanism 200 can vary. FIG. 8 includes a system that includes an oxygen source 32, valve 33, and a regulator 38. The tailored oxygen control mechanism 200 includes the ambient pressure mechanism 210 that adjusts the oxygen based on the ambient pressure being upstream from a breath demand mechanism 220 that adjusts the oxygen based on a demand from the user. FIG. 9 includes an arrangement with the tailored oxygen control mechanism 200 having the breath demand mechanism 220 positioned upstream from the ambient pressure mechanism 210. In both arrangements, a manifold (not illustrated) can be arranged to provide oxygen to multiple users.

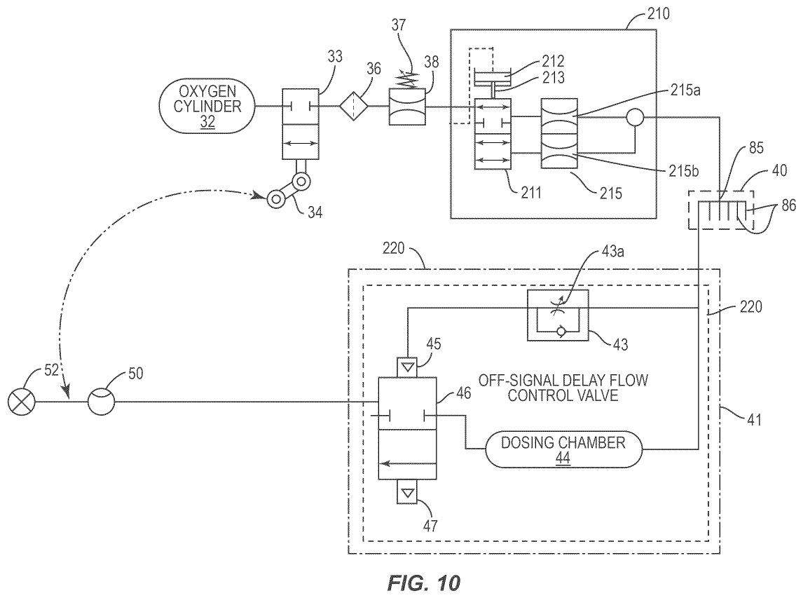

FIG. 10 illustrates a system with the ambient pressure mechanism 210 positioned upstream from the breath demand mechanism 220. The ambient pressure mechanism 210 includes a control valve 211 aligned with multiple orifices 215. An aneroid bellows 212 is connected to a plunger 213 in the control valve 211. A vent associated with the aneroid bellows 212 enables the bellows 212 to expand and contract based on the ambient pressure. This change in size causes the plunger 213 to move within the control valve 211. The plunger 213 aligns relative to orifices 215 that each have a different size and are configured to provide for different oxygen flows. The plunger 213 is positioned relative to the orifices 215a, 215b to enable the desired oxygen flow.

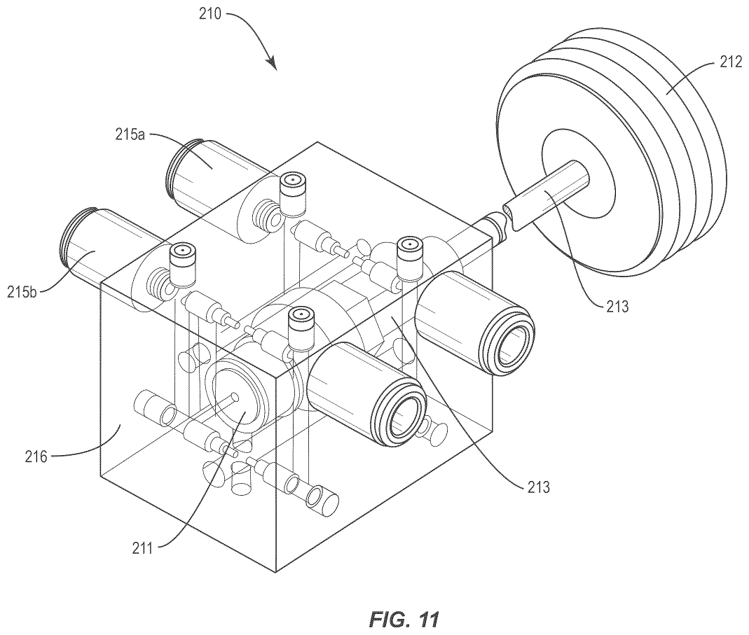

FIG. 11 illustrates an ambient pressure mechanism 210 as schematically shown in FIG. 10. In this example, the ambient pressure mechanism 210 is an aneroid flow switching valve that includes a control valve 211 and orifices 215a, 215b mounted in a body 216. The orifices 215a, 215b include different sizes and enable different flows of oxygen. An aneroid bellows 212 is connected to the plunger 213. The inflation and therefore the size of the bellows 212 varies based on the ambient pressure. This movement causes the plunger 213 to move within the body 216. In some examples, orifice 215a remains open to form a first flow path. The plunger 213 is movable to a first position to close the second orifice 215b such that just the first flow path is open, and a second position to open the second orifice 215b so that both the first flow path and a second flow path are open.

Returning to the system of FIG. 10, oxygen from the ambient pressure mechanism 210 moves through an inlet 85 and into a manifold 40. Manifold 40 includes a plurality of outlets 86 that each lead to separate oxygen control units 41. In this example, the oxygen control units 41 include breath demand mechanisms 220 to tailor the oxygen amount based on the demand of an individual user. The breath demand mechanism 220 includes an oxygen dosing chamber 44 that is maintained at a predetermined pressure that can be at least partially filled and at least partially emptied in response to user demand as sensed by breath sensor 46. A time delay circuit 43 (with time delay circuit orifice 43a) is in communication with the oxygen flow and the breath sensor 46. When oxygen demand (in the form of user inhalation) is sensed by the breath sensor 46, a signal is sent to the time delay circuit 43 to coincide with a dosed release from the oxygen dosing chamber 44. A breathing diaphragm 47 opens on demand to deliver oxygen flow to a user on demand in response to user inhalation, and a conservation diaphragm 45 that closes at the end of a user inhalation to conserve oxygen flow to the user. In some examples, the amount of oxygen in a released dose is based on the breath sensor 46. In other examples, the amount of oxygen is a predetermined set amount.

The oxygen from the control unit 41 is delivered to the delivery device 52. In some examples, an oxygen discharge indicator 50 is positioned along the flow line that leads to the delivery device 52. In other examples, there is no oxygen discharge indicator.

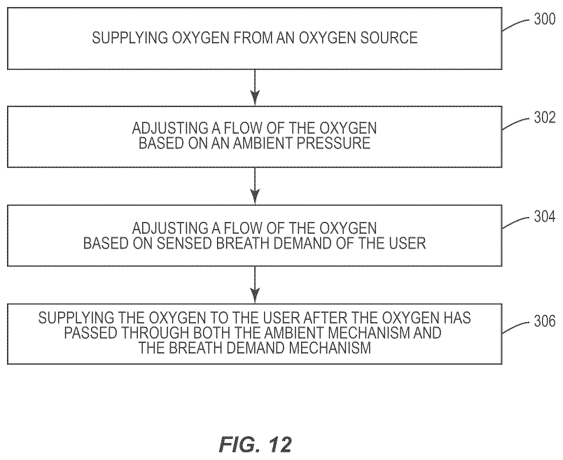

FIG. 12 illustrates a method of mechanically dispensing oxygen to an individual user within an aircraft. The method includes supplying oxygen from an oxygen source 32 (block 300). A flow of oxygen is adjusted based on an ambient pressure at an ambient pressure mechanism 210 (block 302). The flow of the oxygen is adjusted based on a sensed breath demand of the user at a breath demand mechanism 220 (block 304). The oxygen is supplied to the user after the oxygen has passed through both the ambient pressure mechanism 210 and the breath demand mechanism 220 (block 306).

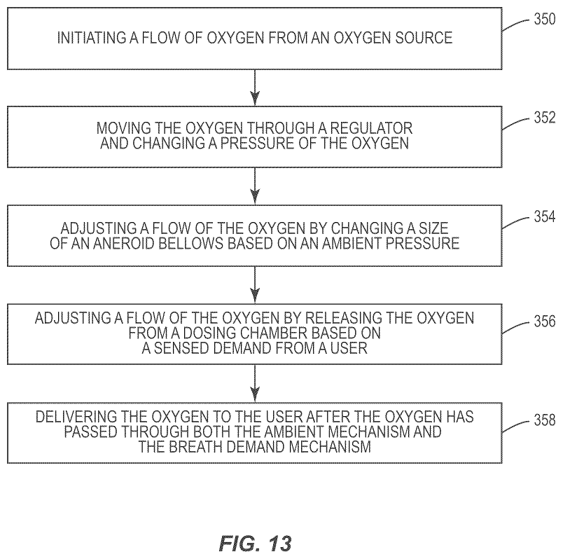

FIG. 13 illustrates another method of mechanically dispensing oxygen to an individual user within an aircraft. The method includes initiating a flow of oxygen from an oxygen source 32 (block 350). The oxygen is moved through a regulator 38 to adjust a pressure of the oxygen (block 352). A flow of the oxygen is adjusted by changing a size of an aneroid bellows 212 of an ambient pressure mechanism 210 based on an ambient pressure (block 354). The flow of the oxygen is adjusted by releasing oxygen from a dosing chamber 44 in a breath demand mechanism 220 based on a sensed demand from a user (block 356). In some examples, this includes the breath demand mechanism 220 sensing the inhalation by the user and releasing the oxygen dose. The oxygen is delivered to the user after the oxygen has passed through the ambient pressure mechanism 210 and the breath demand mechanism 220 (block 358).

The present aspects can, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A system to mechanically dispense oxygen to an individual user within an aircraft, the system comprising:
an oxygen source that contains a supply of oxygen;
a valve positioned downstream from the oxygen source to control a flow of oxygen from the oxygen source;
a regulator positioned downstream from the valve, the regulator configured to reduce a pressure of the oxygen;
a tailored air flow control mechanism positioned downstream from the regulator, the tailored air flow control mechanism comprising:
an ambient pressure mechanism configured to adjust the flow of oxygen based on an ambient pressure;
a breath demand mechanism configured to adjust the flow of oxygen based on a user inhalation; and
a delivery device positioned downstream from the tailored air flow control mechanism, the delivery device configured to supply the oxygen to the user.

2. The system of claim 1, wherein the ambient pressure mechanism is positioned upstream from the breath demand mechanism.

3. The system of claim 1, wherein the ambient pressure mechanism is positioned downstream from the breath demand mechanism.

4. The system of claim 1, further comprising a manifold positioned downstream from the regulator, the manifold comprising an inlet that receives the oxygen and a plurality of outlets to deliver the oxygen.

5. The system of claim 4, wherein the manifold is positioned between the ambient pressure mechanism and the breath demand mechanism.

6. The system of claim 1, wherein the delivery device receives the oxygen directly from the breath demand mechanism.

7. The system of claim 1, further comprising an initiator to enable the valve to be manually operated to release a flow of the oxygen from the oxygen source.

8. A system to mechanically dispense oxygen to an individual user within an aircraft, the system comprising:
a delivery device configured to supply oxygen to the user;
an oxygen source that contains a supply of the oxygen;
a tailored oxygen control mechanism configured to receive the oxygen from the oxygen source and deliver the oxygen to the delivery device, the tailored oxygen control mechanism comprising:
a device to adjust a flow of the oxygen to compensate for ambient pressure;
a breath demand mechanism comprising:
an oxygen dosing chamber that receives the oxygen;
a breath sensor positioned downstream from the oxygen dosing chamber and configured to sense a demand for the oxygen at the delivery device, the breath sensor comprising a breathing diaphragm that delivers the oxygen on demand and a conservation diaphragm that closes at an end of inhalation by the user; and
a time delay circuit in communication with the breath sensor, the time delay circuit configured to control a release of the oxygen from the oxygen dosing chamber.

9. The system of claim 8, wherein the device is an aneroid flow switching valve.

10. The system of claim 8, wherein the device is an aneroid flow switching valve comprising:
a body;
a plurality of orifices that extend through the body;
an aneroid bellows;
a plunger; and
wherein the aneroid bellows is configured to change in sized based on an ambient pressure to selectively open one of the plurality of orifices.

11. The system of claim 8, wherein the device is positioned upstream from the breath demand mechanism.

12. The system of claim 8, wherein the device is positioned downstream from the breath sensor.

13. The system of claim 8, further comprising a manifold positioned between the device and the breath demand mechanism.

14. The system of claim 8, further comprising:
a valve positioned downstream from the oxygen source to control a flow of oxygen from the oxygen source; and
a regulator positioned downstream from the valve, the regulator configured to reduce a pressure of the oxygen.

15. The system of claim 8, wherein the oxygen dosing chamber is configured to maintain the oxygen at a predetermined pressure.

16. The system of claim 8, wherein the time delay circuit is positioned in parallel with the oxygen dosing chamber.

17. A system to mechanically dispense oxygen to an individual user within an aircraft, the system comprising:
a delivery device configured to supply oxygen to the user;
an oxygen source that contains a supply of the oxygen;
an aneroid flow switching valve configured to adjust the flow of oxygen to compensate for ambient pressure;
a control unit positioned downstream from the aneroid flow switching valve and configured to adjust a flow of the oxygen to compensate for a demand for the oxygen, the control unit comprising:
an oxygen dosing chamber that receives the oxygen;
a breath sensor positioned downstream from the oxygen dosing chamber and configured to sense the demand for the oxygen through the delivery device, the breath sensor comprising a breathing diaphragm that delivers the oxygen on demand and a conservation diaphragm that closes at an end of a user inhalation; and
a time delay circuit in communication with the breath sensor, the time delay circuit configured to control a release of the oxygen from the oxygen dosing chamber.

18. The system of claim 17, further comprising a manifold positioned downstream from the aneroid flow switching valve, the manifold comprising an inlet and a plurality of outlets with one of the outlets configured to deliver the oxygen to the control unit.

19. The system of claim 18, wherein the control unit is a first control unit that receives the oxygen from a first one of the outlets and further comprising a plurality of other control units and a plurality of other outlets, wherein each of the other outlets delivers the oxygen to a different one of the other control units.

20. The system of claim 17, wherein the control unit supplies the oxygen directly to the delivery device.

21. A system to mechanically dispense oxygen to an individual user within an aircraft, the system comprising
a delivery device configured to supply oxygen to the user;
an oxygen source that contains a supply of the oxygen;
a valve positioned downstream from the oxygen source to control a flow of oxygen from the oxygen source;
a regulator positioned downstream from the valve, the regulator configured to reduce a pressure of the oxygen;
a manifold positioned downstream from the regulator, the manifold comprising an inlet that is configured to receive the oxygen that flows through the regulator, the manifold further comprising a plurality of outlets;
a control unit that is configured to receive oxygen from one of the outlets, the control unit comprising:
an oxygen dosing chamber that is configured to receive the oxygen from the one outlet;
a breath sensor positioned downstream from the oxygen dosing chamber and configured to sense a demand for the oxygen at the delivery device, the breath sensor 46 comprising a breathing diaphragm that is configured to open to deliver the oxygen on demand to user inhalation at the delivery device, and a conservation diaphragm that is configured to close at an end of the user inhalation;
a time delay circuit positioned between the manifold and the breath sensor; and
an orifice metering device positioned between the breath sensor and the delivery device, the orifice metering device configured to adjust the flow of the oxygen exiting the oxygen dosing chamber to compensate for ambient pressure.

22. A method of mechanically dispensing oxygen to an individual user within an aircraft, the method comprising:
supplying oxygen from an oxygen source;
adjusting a flow of the oxygen based on an ambient pressure at an ambient pressure mechanism;
adjusting the flow of the oxygen based on a sensed breath demand of the user at a breath demand mechanism; and
supplying the oxygen to the user after the oxygen has passed through both the ambient pressure mechanism and the breath demand mechanism.

23. The method of claim 22, further comprising adjusting the flow of the oxygen at the breath demand mechanism prior to adjusting the flow of the oxygen at the ambient pressure mechanism.

24. The method of claim 22, further comprising adjusting the flow of the oxygen at the breath demand mechanism after adjusting the flow of the oxygen at the ambient pressure mechanism.

25. The method of claim 22, further comprising moving the oxygen through a manifold prior to adjusting the flow of the oxygen at the breath demand mechanism.

26. The method of claim 22, further comprising:
delivering the oxygen from the ambient pressure mechanism to a manifold; and
directing the oxygen from the manifold to the breath demand mechanism.

27. The method of claim 22, further comprising adjusting a pressure and a flow of the oxygen prior to adjusting the oxygen based on the sensed breath demand.

28. A method of mechanically dispensing oxygen to an individual user within an aircraft, the method comprising:
initiating a flow of oxygen from an oxygen source;
moving the oxygen through a regulator and changing a pressure of the oxygen;
adjusting a flow of the oxygen by changing a size of an aneroid bellows of an ambient pressure mechanism based on an ambient pressure;
adjusting the flow of the oxygen by releasing the oxygen from a dosing chamber in a breath demand mechanism based on a demand of a user; and
delivering the oxygen to the user after the oxygen has passed through the ambient pressure mechanism and the breath demand mechanism.

29. The method of claim 28, further comprising adjusting the flow of the oxygen at the breath demand mechanism prior to adjusting the flow of the oxygen at the ambient pressure mechanism.

30. The method of claim 28, further comprising adjusting the flow of the oxygen at the breath demand mechanism after adjusting the flow of the oxygen at the ambient pressure mechanism.

31. The method of claim 28, further comprising adjusting a pressure and a flow of the oxygen prior to adjusting the oxygen based on the demand from the user.
